(19) United States
(12) Patent Application Publication
(10) Pub. No.: US 2007/0169606 A1
(43) Pub. Date: Jul. 26, 2007

(54) Power tool having means for removing debris from workpiece

(76) Inventor: Graham Bone, Carrville (GB)

Correspondence Address: Mehul R. Jani;Black & Decker Corporation, Mail Stop TW199, 701 E. Joppa Rd, Towson, MD, 21286, US

(21) Appl. No.: 11/602,619

(22) Filed: Nov. 21, 2006

(30) Foreign Application Priority Data
Nov. 28, 2005 (EP) 05111379.3

(51) Int. Cl. B23D 57/00; B23D 45/00

(52) U.S. Cl. 83/835; 30/166.3

(57) ABSTRACT

A power tool comprising a reciprocating cutting blade is disclosed which has an improved dust or debris extraction arrangement and method. A motor fan is arranged to blow air into a conduit which has an outlet on one side of the power tool. The resulting air stream from the outlet is directed towards the area of a workpiece where the blade interacts with the workpiece. The air stream is off-axis with respect to the intended line of cut of the power tool. As a result, debris ejected on the workpiece is blown by the air stream away from the cut line to leave the cut line visible to the saw's operator during use.

### FIELD OF THE INVENTION

This application claims priority to European Patent Application No. EP 05111379, filed Nov. 28, 2005. The entire contents of that application are expressly incorporated herein by reference thereto.

This invention relates to a power tool having means for removing debris from the workpiece, particularly from an area of the workpiece close to the point at which work is done on the workpiece.

### BACKGROUND OF THE INVENTION

Jigsaws are well known in the field of electrically powered cutting tools. A saw blade is caused to reciprocate such that a workpiece is cut by the blade's action. Debris from the workpiece is thrown by the cutting blade onto workpiece. This debris can obscure to some extent the intended line of cut. As a result, an operator of the jigsaw has to blow or brush the debris off the workpiece before they can proceed with cutting the workpiece along the cut-line.

This problem has been partially addressed by providing a flow of air to the area of the workpiece close to where the saw blade engages the workpiece.

DE 10338602 describes a jigsaw having airflow paths arranged such that a portion of air drawn into the body of the jigsaw by a fan on a drive motor is expelled from a nozzle disposed immediately behind the saw blade. Thus, the expelled air blows debris forward of the blade.

Likewise, DE 3717585 describes a jigsaw having airflow paths arranged in the body of the saw such that air propelled by a motor fan is blown towards an area of the workpiece coincident with the point where the saw blade exits the workpiece.

The prior art devices discussed above only partially solve the problem of clearing debris from the intended direction along which the saw is cutting. The debris is blown forward of the saw, but some debris remains on the cut line, especially when the cut line is straight.

WO 2004080635 describes a jigsaw arranged to drive air via a connecting piece and bridge member towards a jigsaw blade in a direction transverse to a line of cutting action. A suction tube is provided, which can be attached to a vacuum cleaner, on an opposite side of the blade to the bridge member. This arrangement is relatively complex and requires a portion of the connecting piece to be moveable with respect to the bridge member when the angle of the cut is bevelled, that is, when the blade is not perpendicular to a top surface of the workpiece.

### BRIEF SUMMARY OF THE INVENTION

The present invention aims to ameliorate the prior art devices by providing a simplified debris blower on a power tool which suffers less from the problems associated with known debris blower arrangements.

More specifically, the present invention provides an electrically powered manually operated tool, comprising a motor for driving an output shaft to which a saw blade can be coupled, a housing for housing the motor, a base plate coupled to the housing, said base plate comprising a surface arranged to contact a workpiece during use and an aperture through which a saw blade can pass to engage the workpiece, a fan arranged to be driven by the motor and thereby provide a stream of air, and an outlet through which a portion of the stream of air can pass, wherein the outlet is disposed on the housing to one side of a cut line along which a blade is arranged to cut when coupled to the output shaft, said outlet being arranged to direct the stream of air during use at a portion of the workpiece in engagement with the saw blade.

Advantageously, the outlet directs the air across the cut line at an inclined angle (that is, an angle which is not parallel or perpendicular to the cut-line) thereby blowing debris from the top surface of the workpiece and away from the cut line. Disposing the outlet on the housing can simplify the design and reduce the components necessary for the debris blower. Disposing the outlet on the side of the housing, off axis from the cut line, provides a simple means for angling the air stream into debris becomes entrained with respect to the cut line. Thus, debris can be removed from the work area and carried away from the cut line thereby keeping the cut line visible, during use.

Preferably, the fan is disposed in the housing, the outlet is in fluid communication with the fan via a conduit, and the housing comprises an inlet arranged to be in fluid communication with the fan such that during use air drawn into the inlet passes over the motor. Thus, the air can be utilised for cooling motor components.

Preferably, during use the outlet directs the stream of air such that workpiece debris ejected by the saw blade is entrained in the stream of air.

Preferably, the outlet comprises a nozzle. As a result, the velocity of the air exiting from the outlet can be increased thereby improving the removal rate of debris. Furthermore, the nozzle can more accurately direct the air stream to the work area of the workpiece.

Preferably, the outlet is arranged to direct the stream of air at the workpiece at an angle of between 10° and 80° with respect to the cut line. More preferably, the angle is between 30° and 60°.

An embodiment of the present invention is now described by way of example, with reference to the accompanying drawings described below.

### BRIEF DESCRIPTION OF THE DRAWINGS

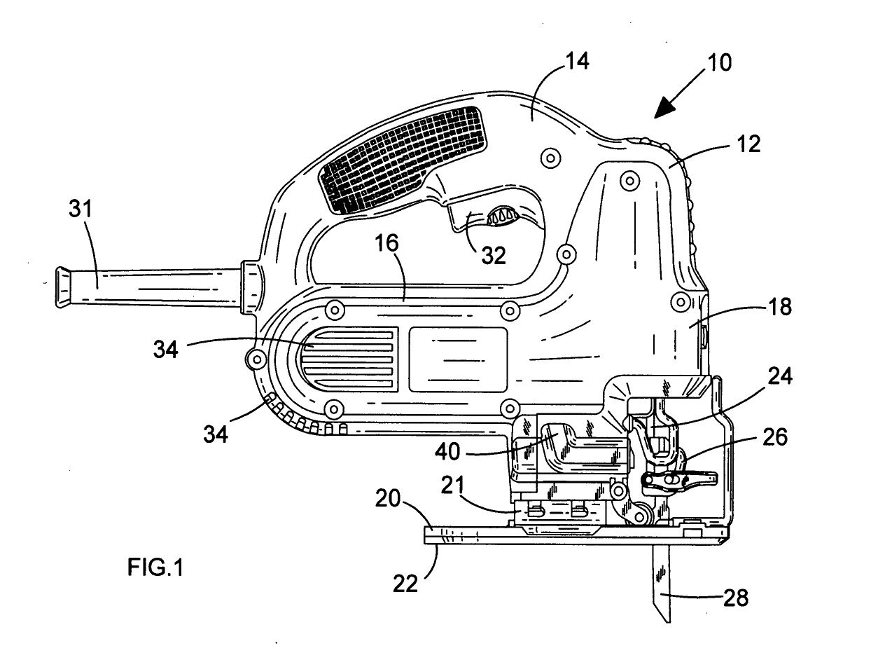

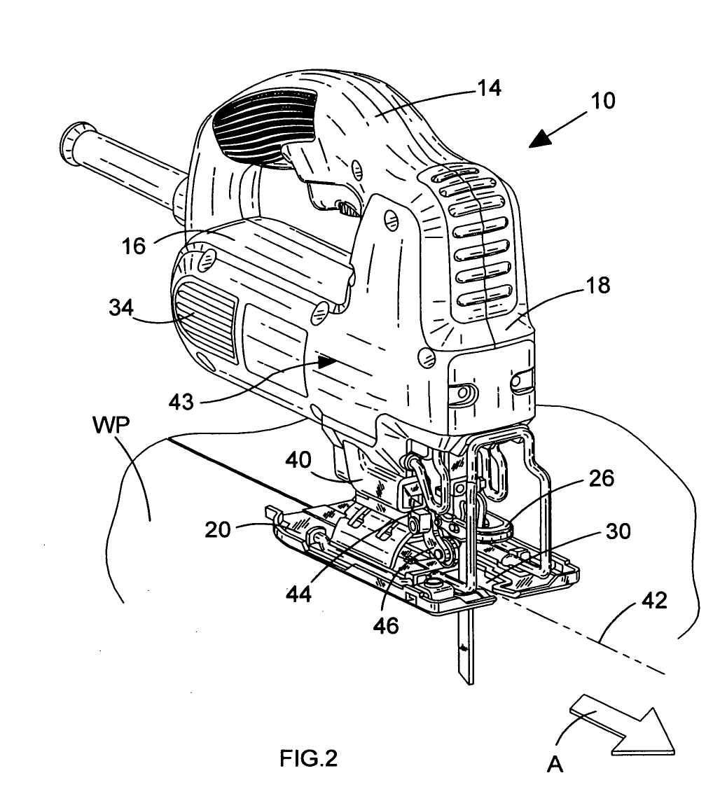

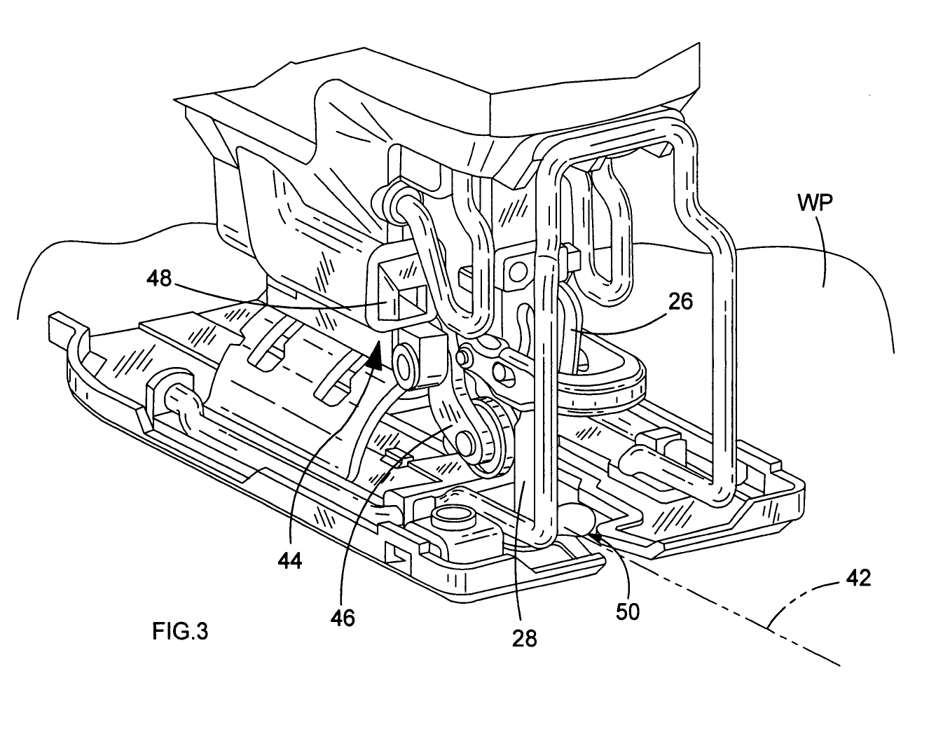

FIG. 1 is a side view of a jigsaw embodying the present invention;
i. FIG. 2 is a view of the jigsaw shown in FIG. 1 from a front perspective; and
ii. FIG. 3 is a detailed perspective view showing components of the jigsaw shown in FIG. 2.

### DETAILED DESCRIPTION OF THE DRAWINGS

Referring to FIG. 1, a jigsaw 10 embodying the present invention is shown. The jigsaw comprises a body 12, having a handle portion 14, a motor housing portion 16 and a gearbox portion 18. A base plate 20 is coupled to the housing by a bridge component 21 and comprises an underside surface 22 which is arranged to engage with a top surface of a workpiece during use. A reciprocating shaft 24 extends from the gearbox portion of the housing and comprises a blade clamp 26 at one end of the shaft. A saw blade 28 is disposed in the blade clamp such that the blade extends through an aperture 30 (see FIG. 2) in the base plate. During use, the blade is in engagement with the workpiece, as is understood by a person of ordinary skill in the art.

A motor is housed in the motor housing portion 16 of the body 12. The motor is coupled to a gearbox disposed in the gearbox portion 18 of the body 12. Electrical power is supplied to the motor via a cord 31. Of course, electrical power could also be supplied by a battery. A manually operable switch 32 is provided to allow an operator to interrupt electrical power to the motor. Power is supplied to the motor by depressing the switch into handle portion 14. When activated by the switch, rotorary motion of the motor is converted to linear reciprocating motion by the gearbox. The reciprocating shaft, and hence the blade coupled thereto, therefore move in a linear manner and perpendicular to the plain defined by the base plate.

A fan is coupled to the motor and disposed between the motor and gearbox such that operation of the motor causes the fan to rotate. Rotation of the fan causes air to be drawn into the motor housing portion of the body through louvered slots 34. Having entered the body of the jigsaw, the air passes over the motor to cool components of the motor during use. The air then enters a volume surrounding the fan. Rotation of the fan causes the air to in the volume to exit the volume via an exit conduit 40.

Referring to FIG. 2, the jigsaw is shown disposed on a workpiece WP. The broken line 42 indicates the intended line along which the jigsaw is cutting, and arrow A indicates the cut direction. The workpiece is cut by the jigsaw in this manner.

The exit conduit 40 is disposed on a side face 43 of the jigsaw body. The conduit extends from the fan volume inside the body to a point where the conduit then forms an enclosed channel on the outer surface of the body. An outlet 44 of the conduit is formed such that an air stream exiting the conduit is directed towards a portion of the workpiece close to the point where the saw blade passes through the top surface of the workpiece. Preferably, the outlet is disposed close to the point where the body is coupled to the base plate 20. Thus, the direction of the air flow in the air stream is off-axis with respect to the line of cut 42. In other words, the air stream is angled with respect to the cut line 42 (the word “angled” being taken to mean that the air stream, or at least a component of the air stream in the plain of the workpiece, is neither parallel with or perpendicular to the cut line).

Debris is thrown onto the top surface of the workpiece as the saw blade cuts through the workpiece. The air stream exiting the outlet 44 blows the debris away from area of workpiece being cut. Furthermore, because the air stream is angled with respect to the cut line 42, the debris is blown away from the cut line thereby keeping the cut line visible to the operator during use. Yet further, the air stream intercepting the debris is not interrupted by components of the jigsaw mechanism, such as a bell crank 46 used to impart pendulum motion on the saw blade during use. In other words, there is a clear line of sight between the outlet and the point on the workpiece where debris is ejected by the action of the saw blade.

Referring to FIG. 3, a portion of the jigsaw embodying the present invention is shown in more detail. The outlet 44 comprises a nozzle member 48. The nozzle is arranged to direct the air stream passing through the outlet towards the area 50 of the workpiece WP where debris is ejected and may land or settle on the workpiece. This area 50 is within a 5-10 millimeters radius of the point where the cutting edge of the saw blade 28 engages with the workpiece. It can be seen that the air stream exiting the outlet and being directed by the nozzle is uninterrupted by components of the jigsaw on its path towards the workpiece area 50. It might be that the blade clamp 26 partially enters the air stream, but because of the clamps reciprocating motion, the air stream is only blocked or partially blocked for short periods of time.

As a result of the foregoing, it is possible to provide a simple and more compact arrangement for a jigsaw. The designer is no longer concerned with having to implement relatively complex arrangements of conduits or pipes from the motor fan to direct air to the workpiece. Furthermore, the bell crank and other jigsaw components can be located in positions which are more optimal to their operation without the need to compromise because of the need to provide sufficient airflow to the workpiece for the removal of debris therefrom. Yet further, angling the air flow with respect to the cut line 42 removes the debris from the cut line thereby improving the visibility of the cut line during use.

The jigsaw can be arranged such that all the air moved by the rotation of the fan passes through the outlet. In other words, the outlet is the only means by which air from the fan is able to be exhausted from the jigsaw's body.

The skilled person will envisage modifications to the embodiment of the present invention described above. For instance, the angle at which the air stream exits the outlet with respect to the cut line could be arranged to be within 10° to 80° of the cut line in horizontal plane.

What is claimed is:

1. An electrically powered manually operated tool, comprising:
a motor for driving an output shaft to which a saw blade can be coupled;
a housing for housing the motor;
a base plate attached to the housing, said base plate comprising a surface arranged to contact a workpiece during use, and an aperture through which a saw blade can pass to engage the workpiece;
a fan arranged to be driven by the motor to provide a stream of air; and
an outlet through which a portion of the stream of air can pass,
wherein the outlet is disposed on the housing offset from a cut line along which a blade is arranged to cut when coupled to the output shaft, said outlet being arranged to direct the stream of air during use at a portion of the workpiece in engagement with the saw blade.

2. The tool of claim 1, wherein the fan is disposed in the housing, the outlet is in fluid communication with the fan via a conduit, and the housing comprises an inlet arranged to be in fluid communication with the fan such that air drawn into the inlet passes over the motor.

3. The tool of claim 1, wherein during use the outlet directs the stream of air to a portion of workpiece such that debris ejected by the saw blade is entrained in the stream of air.

4. The tool of claim 1, wherein the outlet comprises a nozzle.

5. The tool of claim 1, wherein the outlet is arranged to direct the stream of air at the workpiece at an angle substantially between 10° and 80° with respect to the cut line.

6. The tool of claim 1, wherein the outlet is arranged to direct the stream of air at the workpiece at an angle substantially between 30° and 60°.
